(19) United States
(12) Patent Application Publication
(10) Pub. No.: US 2007/0229768 A1
(43) Pub. Date: Oct. 4, 2007

(54) PROJECTION APPARATUS

(75) Inventors: CHENG-FENG HSIEH, MIAO-LI COUNTY (TW); FAN-CHIEH CHANG, MIAO-LI COUNTY (TW); I-MING LIU, MIAO-LI COUNTY (TW)

Correspondence Address: J C PATENTS, INC., 4 VENTURE, SUITE 250, IRVINE, CA, 92618, US

(73) Assignee: CORETRONIC CORPORATION, MIAO-LI COUNTY (TW)

(21) Appl. No.: 11/617,349

(22) Filed: Dec. 28, 2006

(30) Foreign Application Priority Data
Mar. 29, 2006 (TW) 95110855

(51) Int. Cl. G03B 21/26

(52) U.S. Cl. 353/30

(57) ABSTRACT

A projection apparatus including a projection module, a control unit, a housing, a wireless-receiving unit and a control panel is provided. The control unit is electrically connected to the projection module for controlling the projection module. The housing is suitable for accommodating the projection module and the control unit and has a concavity exposed outside. The wireless-receiving unit is disposed inside the housing and is electrically connected to the control unit. The control panel is detachably installed in the concavity. When the control panel is installed in the concavity, the control panel is electrically connected to the control unit such that the control panel is suitable for providing an electric signal to the control unit for controlling the projection module. When the control panel is detached from the concavity, the control panel is suitable for providing a wireless signal to the wireless-receiving unit for controlling the projection module.

### CROSS-REFERENCE TO RELATED APPLICATION

This application claims the priority benefit of Taiwan application serial no. 95110855, filed Mar. 29, 2006. All disclosure of the Taiwan application is incorporated herein by reference.

### BACKGROUND OF THE INVENTION

1. Field of the Invention

The present invention relates to a display apparatus, and more particularly, to a projection apparatus.

2. Description of Related Art

FIG. 1A is a perspective view of a conventional projection apparatus. FIG. 1B is a block diagram showing the structure of the projection apparatus shown in FIG. 1A. As shown in FIGS. 1A and 1B, the conventional projection apparatus 100 includes a projection module 110, a control unit 120, a housing 130, a control panel 140, an infrared-receiving unit 150 and an infrared remote control 160. The projection module 110 projects an image on a screen. The control unit 120 is electrically connected to the projection module 110 for controlling the projection module 110. Both the projection module 110 and the control unit 120 are disposed inside the housing 130.

In addition, the control panel 140 is disposed on the housing 130 and is electrically connected to the control unit 120. The control panel 140 has a plurality of first buttons 142 disposed thereon so that a user controls the projection module 110 by pressing the first buttons 142. The infrared-receiving unit 150 is disposed inside the housing 130 and is electrically connected to the control unit 120. The housing 130 has an opening 132 that exposes a portion of the infrared-receiving unit 150. The infrared remote control 160 has a plurality of second buttons 162. When the user presses the second buttons 162, the infrared remote control 160 emits an infrared signal 164 to the infrared-receiving unit 150 for controlling the projection module 110.

When the projection apparatus 100 needs to be packed away, the infrared remote control 160 is a component separated from the housing 130, and is misplaced or left behind near a location where it was last used. Since the infrared remote control 160 is a relatively small device, finding it is difficult. Ultimately, the infrared remote control 160 is permanently lost.

### SUMMARY OF THE INVENTION

Accordingly, one objective of the present invention is to provide a projection apparatus having a control panel with a wireless control function integrated therewith.

To achieve these and other advantages and in accordance with the purpose of the invention, as embodied and broadly described herein, the invention provides a projection apparatus. The projection apparatus includes a projection module, a control unit, a housing, a wireless-receiving unit and a control panel. The projection module is suitable for projecting an image on a screen. The control unit is electrically connected to the projection module for controlling the projection module. The housing is suitable for accommodating the projection module and the control unit and has a concavity exposed outside. The wireless-receiving unit is disposed inside the housing and is electrically connected to the control unit. The control panel is detachably installed in the concavity. When the control panel is installed in the concavity, the control panel is electrically connected to the control unit such that the control panel is suitable for providing an electric signal to the control unit for controlling the projection module. When the control panel is detached from the concavity, the control panel is suitable for providing a wireless signal; to the wireless-receiving unit for controlling the projection module.

In brief, the projection apparatus in the present invention permits a user to emit a wireless signal through a control panel to remotely control the projection module or transmit a control signal through a circuit to control the projection module after disposing the control panel into the concavity. Therefore, the projection apparatus has a high flexibility in operation. Moreover, the control panel and the projection apparatus are packed together by disposing the control panel into the concavity after use. Hence, the control panel is easier to keep and not so easy to lose.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a perspective view of a conventional projection apparatus.

FIG. 1B is a block diagram showing the structure of the projection apparatus shown in FIG. 1A.

FIG. 2A is a perspective view of a projection apparatus according to one embodiment of the present invention.

FIG. 2B is a block diagram of the projection apparatus shown in FIG. 2A.

FIG. 3A is a perspective view of the projection apparatus in FIG. 2A operated under remote control.

FIG. 3B is a block diagram of the projection apparatus shown in FIG. 3A.

FIG. 4A is a magnified view of a control panel of the projection apparatus shown in FIG. 3A.

FIG. 4B is a magnified view of a concavity on the housing of the projection apparatus shown in FIG. 3A.

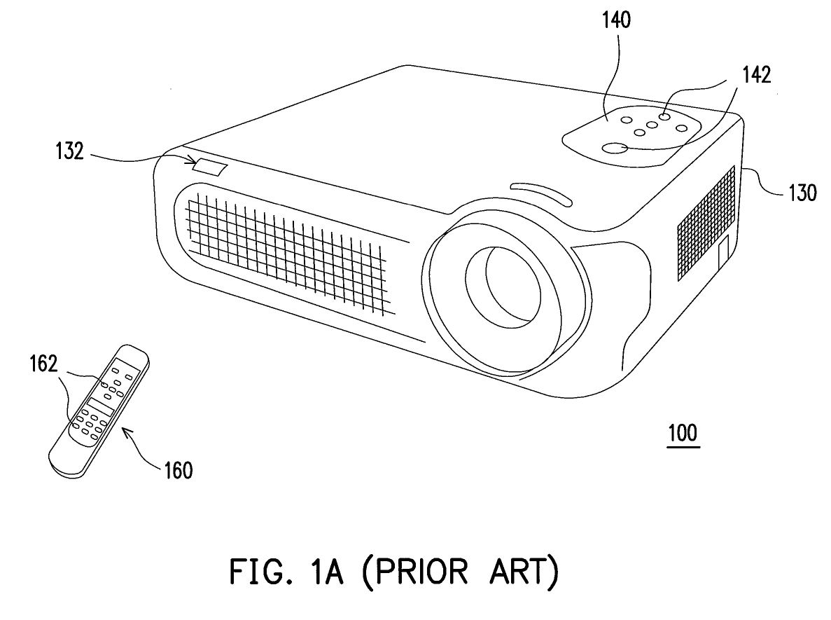

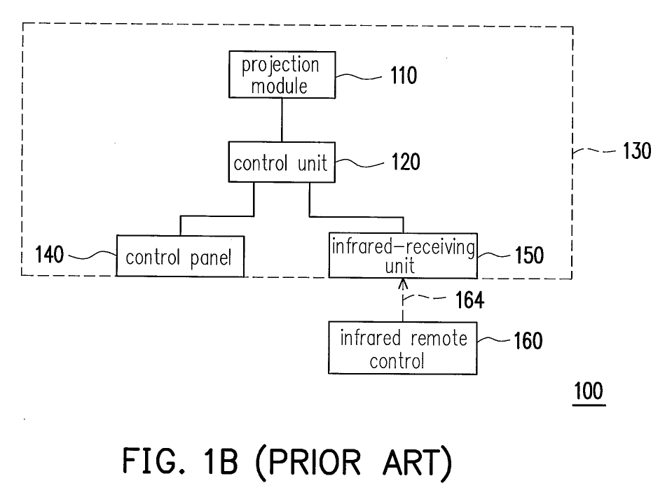

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

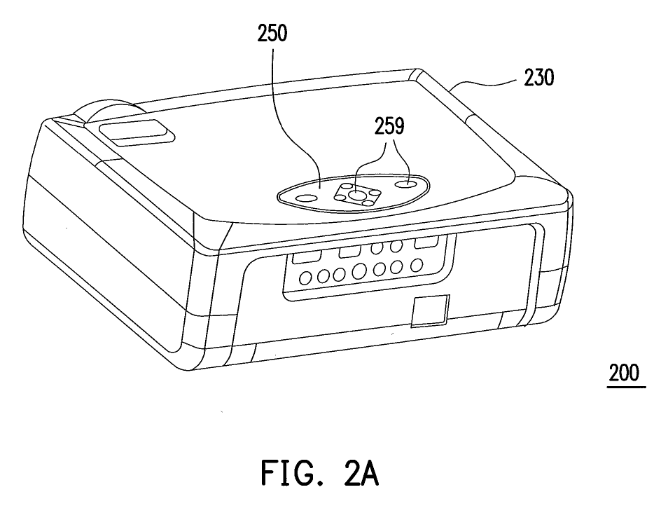

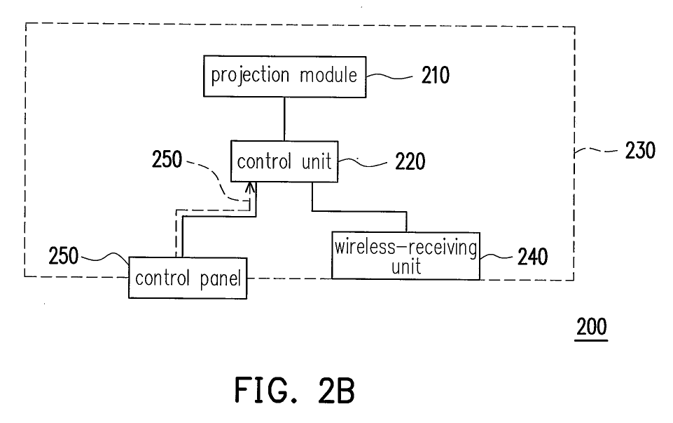

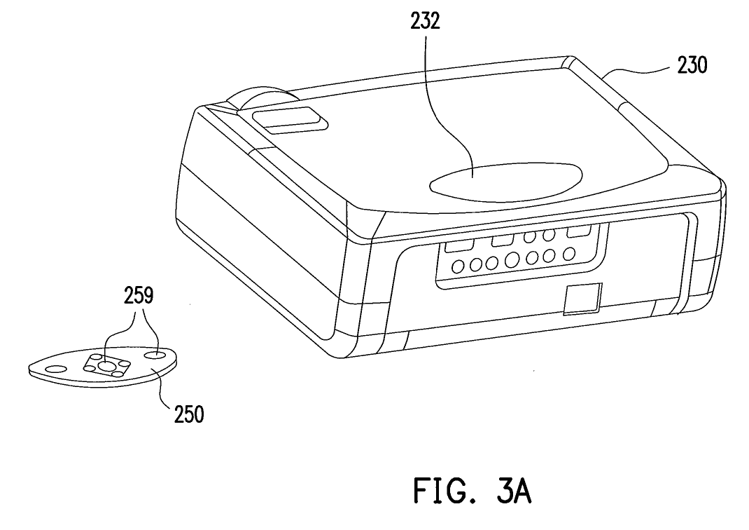

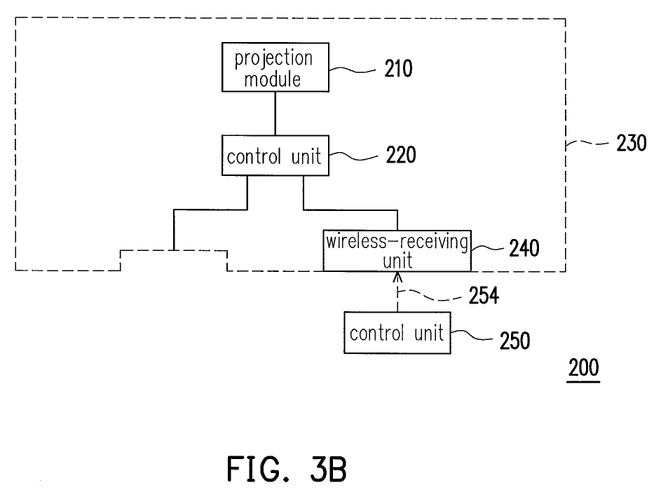

FIG. 2A is a perspective view of a projection apparatus according to one embodiment of the present invention. FIG. 2B is a block diagram showing the structure of the projection apparatus shown in FIG. 2A. FIG. 3A is a perspective view of the projection apparatus in FIG. 2A operated under remote control. FIG. 3B is a block diagram of the projection apparatus shown in FIG. 3A. As shown in FIGS. 2A, 2B, 3A and 3B, the projection apparatus 200 in the present invention includes a projection module 210, a control unit 220, a housing 230, a wireless-receiving unit 240 and a control panel 250. The projection module 210 is suitable for projecting an image on a screen. The control unit 220 is electrically connected to the projection module 210 for controlling the projection module 210. The housing 230 is suitable for accommodating the projection module 210 and the control unit 220 and has a concavity 232 exposed outside. The wireless-receiving unit. 240 is disposed inside the housing 230 and is electrically connected to the control unit. 220. The control panel 250 is detachably installed in the concavity 232.

When the control panel 250 is installed in the concavity 232 (as shown in FIGS. 2A and 2B), the control panel 250 is electrically connected to the control unit 220. The control panel 250 is suitable for providing an electric signal 252 to the control unit 220 for controlling the projection module 210. When the control panel 250 is detached from the concavity 232 (as shown in FIGS. 3A and 3B), the control panel 250 is suitable for providing a wireless signal 254 to the wireless-receiving unit 240 for controlling the projection module 210.

Due to the integration of the wireless remote control function to the control panel 250 in the present invention, a user transmits a wireless signal 254 from the control panel 250 in a remote location for controlling the projection module 210. Alternatively, the control panel 250 is installed in the concavity 232 of the housing 230 20 so that the electric signal 252 from the control panel 250 is transmitted to the control unit 220 through a circuit for controlling the projection module 210. Therefore, the projection apparatus 200 has a high flexibility in operation.

Furthermore, after using the projection apparatus 200, the user puts the control panel 250 into the concavity 232, so that the projection apparatus 200 and the control panel 250 are always kept together. Therefore, the user can conveniently conceal the remote control without having to worry about losing it somewhere. Moreover, there is no need to provide an additional remote control device when the wireless remote control function is integrated to the control panel 250. Thus, the production cost of the projection apparatus 200 is significantly reduced.

It should be noted that the concept in the present invention is entirely different from the conventional concept of latching a remote control to the housing. Firstly, the remote control in the conventional technique is only latched to the housing when it is no longer used. There is no electrical connection between the remote control and any components inside the housing. Secondly, the projection apparatus in the conventional technique still has a control panel other than the remote control. Moreover, the remote control and the control panel control the projection apparatus through wireless signals and electric signals respectively. In other words, the concept of integrating a remote control and a control panel together has not yet been included in the conventional technique.

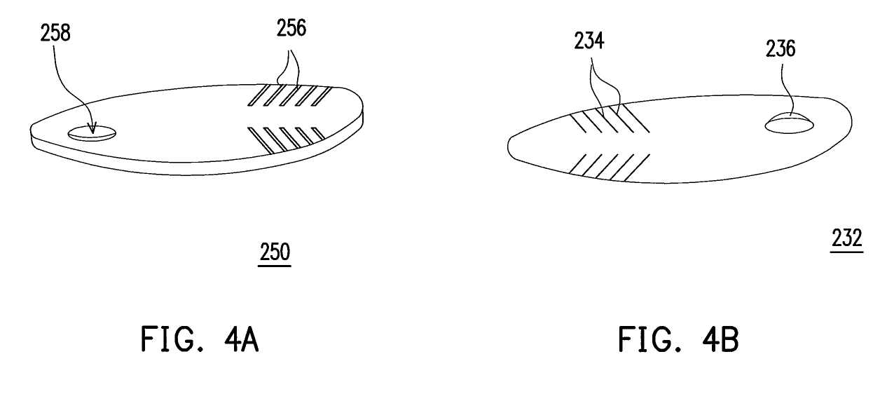

FIG. 4A is a magnified view of the control panel of the projection apparatus shown in FIG. 3A. FIG. 4B is a magnified view of the concavity on the housing of the projection apparatus shown in FIG. 3A. As shown in FIGS. 4A and 4B, a plurality of pushpins 234 is disposed inside the concavity 232. The pushpins 234 are electrically connected to the control unit 220. Moreover, the control panel 250 has a plurality of metal plates 256 corresponding to the pushpins 234. When the control panel 250 is installed in the concavity 232, the metal plates 256 are suitable for contacting the pushpins 234 so that the electric signal 252 provided by the control panel 250 is transmitted to the control unit 220 via the pushpins 234.

Although the pushpins 234 are shown to be disposed on the bottom surface of the concavity 232 and the corresponding metal plates 256 are disposed on the backside of the control panel 250 in the present embodiment, the present invention by no means limits their disposition as such. For example, the pushpins 234 and the metal plates 256 can be disposed on one side of the concavity 234 and on one side of the control panel 250 respectively. Furthermore, the present invention is also not limited to the foregoing method of using pushpins 234 and metal plates 256 to electrically connecting the control panel 250 with the control unit 220. In addition, when the control panel 250 is detached from the concavity 232, a protective cover (not shown) is used to cover the surface of the control panel 250 having metal plates 256. thereon and another protective cover (not shown) is used to cover the concavity 232. The covers prevent dust from accumulating on the metal plates 256 and the pushpins 234 leading to bad contact and avoid someone being hurt by a direct contact with bare metal plates 256. Furthermore, the control panel 250 includes, for example, a signal-switching unit (not shown) suitable for switching the control panel 250 to a wireless-signaling mode (not shown) and an electric-signaling mode (not shown) alternatively. When the control panel 250 is switched to a wireless-signaling mode, it is suitable for emitting a wireless signal 254 to control the projection module 210. On the other hand, when the control panel 250 is switched to the electric-signaling mode, it is suitable for generating an electric signal 252 to control the projection module 210.

In the present embodiment, a switching element 236 corresponding with the signal-switching unit is installed inside the concavity 232. When the control panel 250 is installed in the concavity 232, the switching element 236 electrically contacts with the signal-switching unit so that the signal-switching unit switches the control panel 250 from a wireless-signaling mode to an electric-signaling mode. More specifically, the switching element 236 can be a bump and the signal-switching unit can be a switch. Furthermore, the switch is suitable for switching between a first position (not shown) and a second position (not shown). In addition, the control panel 250 has an opening 258 corresponding with the switching element 236 (the bump) for exposing a portion of the switch.

When the control panel 250 is installed into the concavity 232, the switching element 236 such as the bump is in contact with the switch through the opening 258 so that the switch is changed to the first position and the control panel 250 is switched to the electric-signaling mode. When the control panel 250 is, detached from the concavity 232, the switch is no longer subjected to the external force provided by the switching element 236 such as the bump. Therefore, the switch returns from the first position to the second position so that the control panel 250 changes back to the wireless-signaling mode.

The foregoing method of using the bump and the switch to effect switching is called a mechanical switching. However, the method used by the signal-switching unit for switching the operation modes of the control panel 250 is not limited in the present invention. For example, the signal-switching unit can include a plurality of metal contacts and the switching element 236 can be a metal plate. When the control panel 250 is installed to the concavity 232, the metal plate contacts the metal contacts so that a portion of the circuit of the signal-switching unit turns to short-circuit and the control panel 250 is switched to the electric-signaling mode. When the control panel 250 is detached from the concavity 232, the portion of the circuit of the signal-switching unit returns to an open-circuit condition so that the control panel 250 is switched back to the wireless-signaling mode.

It should be noted that the above switching mechanism of using the metal plate and the metal contacts is known as circuit switching. Since anyone familiar with the technique may easily implement circuit switching, a detailed illustration with a diagram is not provided. In addition, the wireless signal 254 emitted from the control panel 250 is an infrared signal and the corresponding wireless-receiving unit 240 is an infrared receiving unit, for example. Obviously, the present invention does not limit the type of wireless signal 254 or the type of wireless-receiving unit 240 in the wireless transmission. For example, the wireless signal 254 can be a radio frequency signal, a Bluetooth signal or a microwave signal. The corresponding wireless-receiving unit 240 can be a radio frequency receiving unit or a Bluetooth receiving unit.

As shown in FIGS. 2A and 3A, in present embodiment, a plurality of buttons 259 is disposed on the control panel 250. A user presses the buttons 259 to control the various functions such as brightness and contrast adjustments of the projection module 210. In addition, the present invention also permits the integration of games or multimedia interface with the control panel 250 so that the control panel 250 has multiple operating functions. More specifically, the control panel 250 may include a voice control function so that the user can issue voice instructions to the control panel 250 for controlling the projection module.

In summary, the projection apparatus in the present invention has at least the following advantages:

1. With the integration of the wireless remote control function in the control panel in the present invention, there is no need for an extra remote control. Hence, the production cost of the projection apparatus can be reduced.

2. After using the projection apparatus, the user may return the control panel to the concavity of the housing so that the control panel and the projection apparatus remain together. Therefore, the user does not have to take care of the control panel independently so that the chance of losing the control panel is smaller.

3. It is also possible to integrate the control panel with a multimedia interface so that the user can control the projection apparatus by various means.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A projection apparatus, comprising:
a projection module, for projecting an image on a screen;
a control unit, electrically connected to the projection module for controlling the projection module;
a housing, for accommodating the projection module and the control unit and having a concavity exposed outside;
a wireless-receiving unit, disposed inside the housing and electrically connected to the control unit; and
a control panel detachably installed in the concavity, when the control panel is installed in the concavity, the control panel and the control unit are electrically connected, and the control panel is adopted for providing an electric signal to the control unit to control the projection module, when the control panel is detached from the concavity, the control panel is adopted for providing a wireless signal to the wireless-receiving unit to control the projection module.

2. The projection apparatus of claim 1, further comprising a plurality of pushpins disposed in the concavity and electrically connected to the control unit, and wherein the control panel comprises a plurality of metal plates corresponding in position to the pushpins, when the control panel is installed in the concavity, the metal plates are in contact with the respective pushpins, and the electric signal provided by the control panel is transmitted to the control unit via the pushpins.

3. The projection apparatus of claim 1, wherein the control panel comprises a signal-switching unit for switching the control panel to a wireless-signaling mode adopted for providing the wireless signal and an electric-signaling mode adopted for providing the electric signal alternatively.

4. The projection apparatus of claim 3, further comprising a switching element disposed in the concavity, when the control panel is installed in the concavity, the switching element electrically contacts with the signal-switching unit and the signal-switching;unit switches the control panel from the wireless-signaling mode to the electric-signaling mode.

5. The projection apparatus of claim 4, wherein the signal-switching unit is a switch adopted for switching between a first position and a second position, and the switching element is a bump, when the control panel is installed in the concavity, the bump is adopted for moving the switch to the first position and switching the control panel to the electric-signaling mode, when the control panel is detached from the concavity, the switch is adopted for returning to the second position and switching the control panel to the wireless-signaling mode.

6. The projection apparatus of claim 4, wherein the signal-switching unit is a plurality of metal contacts and the switching element is a metal plate, when the control panel is installed in the concavity, the metal plate is adopted for contacting the metal contacts and switching the control panel to the electric-signaling mode, when the control panel is detached from the concavity, the control panel is switched to the wireless-signaling mode.

7. The projection apparatus of claim 1, wherein the wireless signal comprises an infrared signal and the wireless-receiving unit comprises an infrared-receiving unit.

8. The projection apparatus of claim 1, wherein the wireless signal comprises a radio-frequency signal and the wireless-receiving unit comprises a radio-frequency-receiving unit.

9. The projection apparatus of claim 1, wherein the wireless signal comprises a Bluetooth signal and the wireless-receiving unit comprises a Bluetooth receiving unit.

10. The projection apparatus of claim 2, further comprising a protective cover adopted for covering the metal plates when the control panel is detached from the concavity.
